(19) United States
(12) Patent Application Publication
(10) Pub. No.: US 2008/0245737 A1
(43) Pub. Date: Oct. 9, 2008

(54) METHOD AND SYSTEM FOR PROVIDING ULTRAPURE WATER

(75) Inventor: Bruce Lee Coulter, Rockford, IL (US)

Correspondence Address: LOWRIE, LANDO & ANASTASI, LLP;U0105, ONE MAIN STREET, SUITE 1100, CAMBRIDGE, MA, 02142, US

(73) Assignee: SIEMENS WATER TECHNOLOGIES CORP., Warrendale, PA (US)

(21) Appl. No.: 11/872,625

(22) Filed: Oct. 15, 2007

Related U.S. Application Data
(60) Provisional application No. 60/909,795, filed on Apr. 3, 2007.

(51) Int. Cl. C02F 1/68; C02F 1/20; C02F 1/30; C02F 9/12; C02F 9/00; C02F 1/42

(52) U.S. Cl. 210/650; 210/195.1; 210/205; 210/668; 210/742; 210/744; 210/749; 210/750; 210/86

(57) ABSTRACT

A method and system of providing ultrapure water for semiconductor fabrication operations is provided. The ultrapure water is treated by utilizing a free radical scavenging system and a particulate removal system. The free radical scavenging system can utilize actinic radiation with a free radical precursor compound, such as ammonium persulfate. The particulate removal system can comprise one or more ultrafiltration apparatus. The ultrapure water may be further treated by utilizing ion exchange media and degasification apparatus. A control system can be utilized in feedforward or feedback mode to regulate addition of the precursor compound and the actinic radiation source, and to maintain a temperature of the ultrapure water product.

### CROSS-REFERENCE TO RELATED APPLICATION

This application claims the benefit of U.S. Provisional Application No. 60/909,795, filed Apr. 3, 2007, entitled POINT OF USE ULTRA PURE WATER SKID WITH ADVANCED OXIDATION PROCESS, which is incorporated herein by reference in its entirety.

### BACKGROUND OF INVENTION

1. Field of Invention

This invention relates to systems and methods of providing ultrapure water and in particular, to system and methods of reducing or maintaining a contaminant level of ultrapure water used during fabrication of semiconductor devices or components thereof.

2. Discussion of Related Art

Ejzak, in U.S. Pat. No. 4,277,438, discloses a method and apparatus measuring the amount of carbon and other organics in an aqueous solution. A multistage reactor that employs ultraviolet radiation is used to promote oxidation of a test sample. Oxygen and an oxidizing agent such as sodium persulfate are introduced into the solution prior to irradiation.

Martin, in U.S. Pat. No. 6,991,735, discloses a free radical generator and method of sanitizing water systems.

### SUMMARY OF THE INVENTION

One or more aspects of the invention relate to a method of providing ultrapure water to a semiconductor fabrication unit. In some embodiments of the invention, the method can comprise one or more acts of providing inlet water having a total organic carbon (TOC) value of less than about 25 ppb; introducing at least one free radical precursor compound into the water; converting the at least one free radical precursor compound into at least one free radical scavenging species; removing at least a portion of any particulates from the water to produce the ultrapure water; and delivering at least a portion of the ultrapure water to the semiconductor fabrication unit.

One or more aspects of the invention relate to a system for providing ultrapure water to a semiconductor fabrication unit. In some embodiments of the invention, the system can comprise a source of water having a TOC value of less than about 25 ppb; an actinic radiation reactor fluidly connected to the source of water and configured to irradiate water from the source of water; a source of a precursor compound disposed to introduce a free radical precursor compound to the water; and a particulate filter fluidly connected downstream of the actinic radiation reactor and upstream of an ultrapure water distribution system fluidly connected to the semiconductor fabrication unit.

One or more aspects of the invention relate to a system for treating water. In accordance with some embodiments of the invention, the system can comprise a free radical scavenging system fluidly connected to a source of water having a resistivity of at least 15 megohms; a particulate removal system fluidly connected downstream of the free radical scavenging system; an ultrapure water delivery system fluidly connected downstream of the particulate removal system, and a water return system fluidly connecting the ultrapure water delivery system to the free radical scavenging system.

One or more aspects of the invention relate to a computer-readable medium having computer-readable signals stored thereon that define instructions that as a result of being executed by at least one processor instruct the at least one processor to perform a method of regulating addition of at least one free radical precursor compound into an inlet water having a TOC value of less than about 25 ppb. The executed method can comprise acts of generating one or more drive signals based at least partially on the TOC value of the inlet water; and transmitting the one or more drive signals to at least one source of the at least one precursor compound, the at least one source disposed to introduce the at least one precursor compound into the inlet water.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing.

In the drawings:

FIG. 1 is a schematic drawing illustrating a system in accordance with one or more embodiments of the invention;

FIG. 2 is schematic drawing illustrating a processor or control system upon which one or more embodiments of the invention may be practiced; and

FIG. 3 is a graph showing the water quality of the ultrapure water product in accordance with some embodiments of the invention.

### DETAILED DESCRIPTION

One or more aspects of the invention can be directed to water treatment or purification systems and techniques. The various systems and techniques of the invention typically utilize or comprise one or more unit operations that remove undesirable species from a process fluid or stream. A plurality of unit operations may be utilized serially or in parallel flow arrangement to facilitate non-selective or selective removal or a reduction of concentration or level of a variety of target species or compounds, which are typically undesirable or objectionable, in a process stream. Further, the systems and techniques of the invention may utilize one or more unit operations to facilitate adjustment of a concentration of a species or a byproduct species generated from a unit operation of the system. Some aspects of the invention can be directed to techniques and systems or components thereof that treat or purify water that, in some cases, can be characterized as having a low level of impurities or contaminants. Some advantageous aspects of the invention can be directed to systems and techniques that provide ultrapure water. Particularly advantageous aspects of the invention can be directed to systems and techniques that provide ultrapure water for use in semiconductor processing or fabrication operations. In some cases, the invention provides systems and techniques that provide make-up water in a circulating ultrapure water system in a manner that maintains an ultrapure characteristic of the water circuit containing ultrapure water. The systems and techniques of the invention may, in some cases, co-mingle make-up or inlet ultrapure water with treated ultrapure water. Still further aspects of the invention can be directed to control systems and techniques suitable for use with water treatment or purification systems. Even further aspects of the invention can be directed to control systems and techniques that facilitate semiconductor fabrication operations by providing ultrapure water. Indeed, some aspects of the invention may be directed to the control systems and techniques that facilitate ultrapure water treatment or purification by utilizing a feedforward or a feedback approach or both.

In accordance with at least one aspect of the invention, some embodiments thereof can involve a system for treating water. The system and techniques of the invention can involve a first process train that relies or utilizing purified water to create conditions that are conducive to free radical scavenging along with one or more ancillary process trains with unit operations that remove or at least reduce the concentration of byproducts of upstream processes. The system for treating water can comprise at least one free radical scavenging system fluidly connected to at least one source of water that is pure, or even ultrapure, and preferably water having a resistivity of at least 15 megohms. The system for treating water can also comprise at least one particulate removal system that is fluidly connected downstream of the at least one free radical scavenging system and at least one ultrapure water delivery system that is fluidly connected downstream of at least one particulate removal system. Further the system for treating water typically also comprises at least one water return system that fluidly connects the at least one ultrapure water delivery system to at least one of the free radical scavenging systems. The free radical scavenging system, in some cases, can consist essentially of, or preferably, comprise at least one source of at least one precursor compound. Typically, the at least one source of at least one precursor compound is disposed or otherwise constructed and arranged to introduce at least one free radical precursor compound into at least a portion the water from the at least one source of water. The free radical scavenging system can further consist essentially of or comprise at least one source of actinic radiation with or without at least one further alternative apparatus that can also initiate or converts at least one precursor compound into at least one free radical scavenging species in the water. In still other cases, the particulate removal system can comprise at least one ultrafiltration apparatus. Typically, at least one ultrafiltration apparatus is fluidly connected downstream of the at least one source of actinic radiation or at least one free radical initiating apparatus and, preferably, upstream of at least one ultrapure water delivery system.

In accordance with at least one further aspect of the invention, some embodiments thereof can involve a system for providing ultrapure water to a semiconductor fabrication unit. The system can comprise one or more sources of water fluidly connected to at least one actinic radiation reactor. The at least one reactor is preferably configured to irradiate water from the source of water. The system can further comprise one or more sources of a precursor compound. The one or more sources are preferably disposed to introduce one or more free radical precursor compounds into the water from the one or more water sources. The system can also comprise at least one particulate filter fluidly connected downstream of at least one of the one or more actinic radiation reactors and, preferably, upstream of an ultrapure water distribution system. The ultrapure water distribution system is, in some advantageous embodiments of the invention, fluidly connected to the semiconductor fabrication unit. The water source typically provides water having a total organic carbon (TOC) value of less than about 25 ppb. The system for providing ultrapure water can further comprise a recycle line that fluidly connects the ultrapure water distribution system, typically an outlet port thereof, with the at least one of the source of water, the actinic radiation reactor, and the particulate filter.

In accordance with some aspects, some embodiments of the invention can involve a method of providing ultrapure water to a semiconductor fabrication unit. The method can comprise one or more acts of providing inlet water having a TOC value of less than about 25 ppb and introducing at least one free radical precursor compound into the water, and converting the at least one free radical precursor compound into at least one free radical scavenging species. The method can further comprise one or more acts of removing at least a portion of any particulates from the water to produce the ultrapure water, and delivering at least a portion of the ultrapure water to the semiconductor fabrication unit.

In accordance with other aspects, some embodiments of the invention can involve a computer-readable medium having computer-readable signals stored thereon that define instructions that as a result of being executed by at least one processor, instruct the at least one processor to perform a method of regulating addition of at least one free radical precursor compound into an inlet water. The inlet water, in some cases, can be pure or ultrapure water, but preferably has a TOC value of less than about 25 ppb. The method executable by the at least one processor can comprise one or more acts of generating one or more drive signals based at least partially on the TOC value of the inlet water; and transmitting the one or more drive signals to at least one source of the at least one precursor compound, the at least one source disposed to introduce the at least one precursor compound into the inlet water.

In one or more embodiments, any of which may be relevant to one or more aspects of the invention, the systems and techniques disclosed herein may utilize one or more systems that adjusts or regulates or at least facilitates adjusting or regulating at least one operating parameter, state, or condition of at least one unit operation or component of the system or one or more characteristics or physical properties of a process stream. To facilitate such adjustment and regulatory features, one or more embodiments of the invention may utilize controllers and indicative apparatus that provide a status, state, or condition of one or more components or processes. For example, at least one sensor may be utilized to provide a representation of an intensive property or an extensive property of, for example, water from the source, water entering or leaving the free radical scavenging system, or water entering or leaving the particulate removal system. Thus, in accordance with a particularly advantageous embodiment, the systems and techniques of the invention may involve one or more sensors or other indicative apparatus, such as composition analyzers, that provide, for example, a representation of a state, condition, characteristic, or quality the water entering or leaving any of the unit operations of the system.

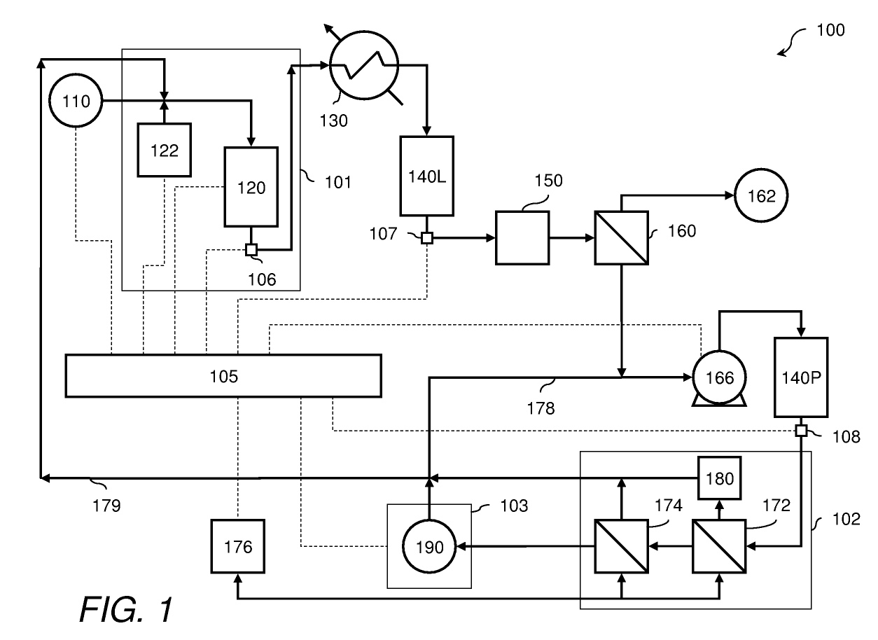

FIG. 1 schematically embodies a system 100 in accordance with one or more aspects of the invention. System 100 can be representative of a water treatment or purification system that provides water including water that can be considered to be ultrapure water. In some particularly advantageous embodiments of the invention, system 100 can be directed or be representative of a purification system providing ultrapure water suitable for semiconductor fabrication facilities or at least maintaining an ultrapure water quality. Still further aspects of the invention involve a system 100 that can be considered as utilizing ultrapure water to provide treated ultrapure water to one or more semiconductor fabrication units (not shown). Thus, in accordance with some aspects of the invention, system 100 can be a water treatment system that reduces a concentration, content, or level of one or more impurities or contaminants that may be present in make-up or inlet water from one or more water sources 110 and provide the treated water to a system that utilizes ultrapure water.

As exemplarily illustrated, system 100 can comprise one or more first or primary treatment trains or systems 101 coupled to one or more second or secondary treatment trains or systems 102. System 100 may further comprise at least one water distribution system 103 fluidly connected to at least one secondary treatment system and, in some even more advantageous configurations, to at least one primary treatment system. Further advantageous embodiments can involve configurations that involve at least one flow directional control devices in at least one of the primary treatment system, the secondary treatment system, and the water distribution system. Non-limiting examples of directional flow control devices include check valves and weirs.

Preferably, source 110 provides water consisting of, consisting essentially of, or comprising a low level of impurities. More preferably, water from source 110 consists of, consists essentially of, or comprises ultrapure water having at least one characteristic selected from the group consisting of a total organic carbon level or value of less than about 25 ppb or even less than about 20 ppb, as urea, and a resistivity of at least about 15 megohms or even at least about 18 megohms. Free radical scavenging system 101 can further comprise at least one source 122 of a precursor compound fluidly connected to reactor 120.

Water introduced into system 100 from source 110 typically, or even preferably, can be characterized by having a low level of impurities. For example, some embodiments of the invention utilize pure or ultrapure water or mixtures thereof that have previously been treated or purified by one or more treatment trains (not shown) such as those that utilize reverse osmosis, electrodialysis, electrodeionization, distillation, ion exchange, or combinations of such operations. As noted, advantageous embodiments of the invention involve ultrapure inlet water from source 110 that typically has low conductivity or high resistivity of at least about 15 megohms, preferably at least about 18 megohms, and/or has a low level of contaminants as, for example, a low total organic carbon level of less than about 50 ppb, and preferably, less than about 25 ppb, typically as urea or other carbon compound or surrogate.

In some particular embodiments of the invention, first treatment system 101 can be characterized or comprise at least one free radical scavenging system. The free radical scavenging system 101 can comprise at least one free radical scavenger reactor 120 fluidly connected to at least one source 110 of water. Reactor 120 can be a plug flow reactor or a continuously stirred tank reactor, or combinations thereof. Reactor 120 is typically sized to provide a residence time sufficient to allow free radical species in the water flowing in reactor to scavenge, degrade, or otherwise convert at least one of the impurities, typically the organic carbon-based impurities into an inert compound, one or more compounds that may be removed from the water, or at least more readily removed relative to the at least one impurity. Organic compounds in the water can be oxidized by one or more free radical species into carbon dioxide, which can be removed in one or more downstream unit operations. Reactor 120 can further comprise at least one free radical activation device that converts one or more precursor compounds into one or more free radical scavenging species. For example, reactor 120 can comprise a plurality of lamps, in or ore more reaction chambers, to irradiate or otherwise provide actinic radiation to the water and divides the precursor compound into the one or more free radical species. Preferably, at least three reactor chambers, each having at least one ultraviolet (UV) lamp disposed to irradiate the water in the respective chambers with light of about 185 nm, 220 nm, and/or 254 nm at various power levels, are serially arranged in reactor 120.

Commercially available sources of actinic radiation systems or free radical scavenging systems include those from Quantrol, Naperville, Ill., as the AQUAFINE UV system, and from Aquionics Incorporated, Erlanger, Ky.

As noted, the invention is not limited to a single precursor compound and may utilize a plurality of precursor compounds. A plurality of precursor compounds may be utilized to generate a plurality of free radical species. This complementary arrangement may be advantageous in conditions where a first free radical scavenging species selectively degrades a first type of undesirable compound and a second free radical species selectively degrades other undesirable compounds. Alternatively, a first precursor compound may be utilized that can be readily converted to a first converted species or a first free radical species. The first free radical species can then convert a second precursor compound into a second converted species or a second free radical species. This cascading set of reactions may also be advantageous in conditions where the first free radical species selectively degrades a first type of undesirable compound and the second free radical species selectively degrades other undesirable compounds or in cases, where conversion or activation of the second precursor compound into the second free radical species undesirably requires high energy levels. A plurality of compounds may be used to provide a plurality of scavenging species.

In some cases, system 100 can comprise at least one degasifier 160 and, optionally, at least one particulate filter downstream of reactor 120. In some cases, system 100 can further comprise at least one apparatus that removes at least a portion of any ionic or charged species from the water. For example, system 100 in one or both of scavenging system 101 or particulate removal system 102 can comprise a bed of ion exchange media or an electrically-driven ion purification apparatus, such as an electrodialysis apparatus or an electrodeionization apparatus. In particularly advantageous configurations of the invention, system 100 can comprise a first, primary or leading ion exchange column 140L comprising an ion exchange resin bed and a second, lagging or polishing ion exchange column 140P, also comprising ion exchange resin bed, are serially disposed, relative to each other, along a flow path of the water through system 100. The ion exchange columns may comprise a mixed bed of anion exchange media and cation exchange media. Other configurations, however, may be utilized. For example, lead ion exchange column 140L may comprise serially arranged layers or columns; the first layer or column can predominantly comprise anion exchange media and the second column can predominantly comprise cation exchange media. Likewise, although polish column 140P can comprise a mixed bed of anion exchange media and cation exchange media, polish column 140P may comprise serially arranged layers of columns of a type of exchange media; the first column can predominantly comprise anion exchange media and the second column can predominantly comprise cation exchange media. Any of the first and second layers or columns may be disposed within a single vessel comprising 140L or 140P and be practiced as layered beds of media contained within the columns. The ion exchange media in ion exchange columns 140L and 140P may be any suitable resin including those that remove sulfate species, carbon dioxide, and ammonia or ammonium and any other undesirable species or contaminant in the water from source 110 or as a byproduct of the free radical scavenging process. Commercially available media that may be utilized include, but are not limited to, NR30 MEG PPQ and USF™ MEG PPQ resins from Siemens Water Technologies Corp., Warrendale, Pa., Rohm and Haas, Philadelphia, Pa., and DOWEX® resin from The Dow Chemical Company, Midland, Mich.

The one or more precursor compounds can be any compound that can be converted to or facilitates conversion of a free radical scavenging species. Non-limiting examples include persulfate salts such as alkali and alkali metal persulfates and ammonium persulfate or ammonium persulfate, hydrogen peroxide, peroxide salts such as alkali and alkali metal peroxides, perborate salts such as alkali and alkali metal perborates, peroxydisulfate salts such as alkali and alkali metal peroxydisulfate and ammonium peroxydisulfate, acids such as peroxydisulfuric acid, peroxymonosulfuric acid or Caro's acid, and ozone, combinations thereof such as piranha solution. The amount of precursor compound can vary depending on the type of contaminant. The precursor compound can consist of or consist essentially of ammonium persulfate which may be advantageous in semiconductor fabrication operations because it would likely provide byproducts that are not considered contaminants of such operations or because they can be readily removed by, for example, ion exchange systems, in contrast to precursor compounds comprising sodium persulfate which can produce sodium species that are not readily removable and/or can undesirably contaminate a semiconductor device.

In some further embodiments of the invention, second treatment system 102 can comprise or be characterized as a particulate removal system. For example, system 100 can further comprise at least one particulate filter 150. Filter 150 typically comprises a filtering membrane that removes or traps particles of at least a target size. For example, filter 150 can be constructed with filtering media or membrane that traps all or at least a majority of particles with an average diameter of at least about 10 microns, in some cases, at least about 1 micron, in still other cases, at least about 0.05 micron, and even at least about 0.02 micron, depending on the service requirements of the point of use connected to the distribution system 103. Filter 150 can comprise a cartridge filter with a membrane that retains particles greater than about 0.01 micron.

A particulate filter (not shown) may optionally be utilized to remove particulates introduced with the one or more precursor compounds from source 122. This filter, like filter 150 may also remove particulates greater than 0.02 micron.

In some cases, particulate removal system 103 can comprise one or more ultrafiltration apparatus 172 and 174, each comprising a membrane that prevents particles having an undesirable size characteristic to flow into the water distribution system with product water. Preferably at least two ultrafiltration apparatus are serially arranged to facilitate a target or desirable concentration of particulates having, for example, greater than about 0.1 micron, and in some cases, greater than 0.05 micron, and even greater than 0.02 micron. For example, the ultrafiltration apparatus 172 and 174 may comprise membranes that reduces or otherwise provides a concentration of particulates larger than 0.05 micron to a level of less than about 100 counts per liter of product water to the point of use. The construction and arrangement of the ultrafiltration apparatus 172 and 174 may depend on the target particulate concentration and the size of the particulates in the ultrapure water product. In some embodiments of the invention, filter 172 removes at least a majority of the particulates of target size and filter 174 serves as a polish to ensure that the concentration of particulates to water distribution system 103 is at a level that is less than or equal to the target or desired particulate concentration. In such configurations, a retentate water stream from filter 172 typically contains a majority of the trapped particulates and can be discharged or discarded or used in other processes. Preferably, however, at least a portion of the retentate water stream is introduced into a particulate filter 180 comprising a membrane or media that traps at least a portion of the particulates; the permeate stream therefrom, from which a substantial portion of particulates is removed, can be directed to and mixed with an upstream unit operation of the system 100 such as, but not limited to, a returning or circulating unused ultrapure product water from distribution system 103, inlet water from source 110 introduced into the free radical scavenging system 101, at least partially treated water from reactor 120, filter 150, degasifier 160, lead ion exchange column 140L or polish ion exchange column 140P, or combinations thereof. Like filter 150, filter 180 can also be constructed to remove or reduce a level particulate material of a certain size to a particular level.

Degasifier 160 can comprise a membrane contactor or any unit operation that reduces a concentration of any dissolved gases in the water or other byproduct of the precursor compound. Preferably, the degasifier reduces any of the dissolved oxygen content, the dissolved nitrogen content, and the dissolved carbon dioxide content in the water. Typically, degasifier 160 utilizes a contacting membrane and a vacuum source 162 that facilitates removal of the dissolved gases from the water. Non-limiting examples of degasifiers that may be utilized herein includes those commercially available as LIQUI-CEL® membrane contactors from Membrana, Charlotte, N.C.

Other ancillary unit operations may be utilized to adjust at least one intensive or extensive property of the water provided to a point of use, which can be the semiconductor fabrication unit. For example, a heat exchanger, such as a chiller 130, may be disposed upstream of ultrapure water distribution system 103 to reduce the temperature of at least a portion of the ultrapure water deliverable to at least one semiconductor fabrication unit. As illustrated, chiller 130 is disposed downstream of reactor 120 but upstream of degasifier 160. The invention, however, is not limited to the exemplary presented arrangement and one or more heat exchangers may be, for example, in thermal communication with the ultrapure water product downstream of particulate removal system 102 but upstream of water distribution system 103. Indeed, a plurality of heat exchangers may be utilized. For example, a first heat exchanger, such as a heater, may heat the water having at least free radical precursor compound to assist in initiating or converting the precursor compound into one or more free radical scavenging species and second heat exchanger, such as a chiller, may cool the treated ultrapure water prior to delivery through the water distribution system.

Still other ancillary systems include, for example, one or more pumps 166 that provide motive force for circulating the water through system 100. Pump 166 may be a positive displacement pump or a centrifugal pump. Preferably, pump 166 comprises components that do not undesirably contribute to the contamination characteristics of the product water.

Water distribution system 103 can comprise an inlet port and at least one outlet port fluidly connected to and providing ultrapure product water to one or more points of use (not shown), such as one or more semiconductor fabrication units. In some cases, for example, distribution system comprises a manifold 190 having an inlet port fluidly connected to free radical scavenging system 101, particulate removal system 102, or both, and at least one product outlet fluidly connected to at least one points of use, and at least one return outlet port fluidly connected to one or more circulating systems 178 and 179 to recycle unused product water to one or both of the free radical scavenging system and the particulate removal system or into any point in system 100.

System 100 can further comprise one or more control systems or controllers 105. Control system 105 is typically connected to one or more sensors or input devices configured and disposed to provide an indication or representation of at least one property, characteristic, state or condition of at least one of a process stream, a component, or a subsystem of treatment system 100. For example, control system 105 can be operatively coupled to receive input signals from any one or more of source 110 and sensors 106, 107, and 108. The input signals can be representative of any intensive property or any extensive property of the water from source 110, the treated ultrapure water from ion exchange column 140L, and ion exchange column 140P. For example, one or more input signals from source 110 can provide an indication of the resistivity or conductivity, the flow rate, the TOC value, the temperature, the pressure, the concentration of metals, the level or amount of bacteria, the dissolved oxygen content, and/or the dissolved nitrogen content of the inlet or make-up water. Input devices or sensors 106, 107 and 108 may likewise provide any one or more such representations of the at least partially treated water through system 100. In particular, sensor 106, 107, or 108 can be a sensor that provides an indication of the temperature of the at least partially treated water or ultrapure water. Although only sensors 106, 107, and 108 are particularly depicted, additional sensor may be utilized including, for example, one or more temperature, conductivity or resistivity sensors in water distribution system 103.

Control system 105 can be configured to receive any one or more input signals and generate one or more drive, output, and control signals to any one or more unit operations or subsystems of treatment system 100. As illustrated, control system 105 can, for example, receive an indication of a flow rate, a TOC level, or both, of water from source 110. Control system 105 can then generate and transmit a drive signal to source 122 of precursor compound to, if necessary, adjust the rate of addition of the precursor compound introduced into the water stream entering reactor 120. The drive signal is typically based on the one or more input signals and a target or predetermined value or set-point. For example, if the input signal that provides representation of the TOC value of the inlet water from source 110 is above the target TOC value or a range of acceptable TOC value, i.e., a tolerance range, then the drive signal can be generated to increase an amount or a rate of addition of the precursor compound from source 122. The particular target values are typically field-selected and may vary from installation to installation and be dependent on downstream, point of use requirements. This configuration inventively avoids providing water having undesirable characteristics by proactively addressing removal of contaminants and also avoids compensating for the system's residence or lag response time, which can be a result of water flowing through the system and/or the time required for analysis.

Control system 105 may further generate and transmit additional control signals to, for example, energize or adjust an intensity or power of output radiation emitted by at least one radiation source in reactor 122. Thus, depending on the amount or rate of addition of the precursor compound, or on the level of TOC in the water stream entering reactor 120, the control signal may be increased or decreased appropriately, incrementally or proportionally. This feature serves to prolong service life of the one or more radiation sources and reduce energy consumption.

Control system 105 may also be configured in feedback arrangement and generate and transmit one or more control signals to any one or both of the precursor compound source 122 and reactor 120. For example, the TOC value or the resistivity, or both, of the ultrapure product water in distribution system 103, or from the sensors 107 or 108, may be utilized to generate control signals to any of source 122 and reactor 120.

During periods of high initial TOC fluctuations, the feedforward control can be utilized to compensate for instrument delay. This preemptive approach injects the precursor compound, typically at a surplus relative to the amount of contaminants. During periods of stable TOC levels, the feedback approach may be utilized with or without the feedforward control.

Control system 105 may further generate and transmit a control signal that adjusts a rate of heat transfer in chiller 130 based on, for example, an input signal from sensors 107 or 108, or both. The control signal may increase or decrease the flow rate and/or the temperature of the cooling water introduced into chiller 130 to provide treated water to distribution system 103 at a desired or predetermined temperature.

Control system 105 may further generate and transmit a control signal that energizes pump 166 or adjust a flow rate of the at least partially treated water flowing therethrough. If the pump utilizes a variable frequency drive, the control signal can be generated to appropriately adjust the pump motor activity level to achieve a target flow rate value. Alternatively, an actuation signal may actuate a valve that regulates a rate of flow of the at least partially treated water from pump 166.

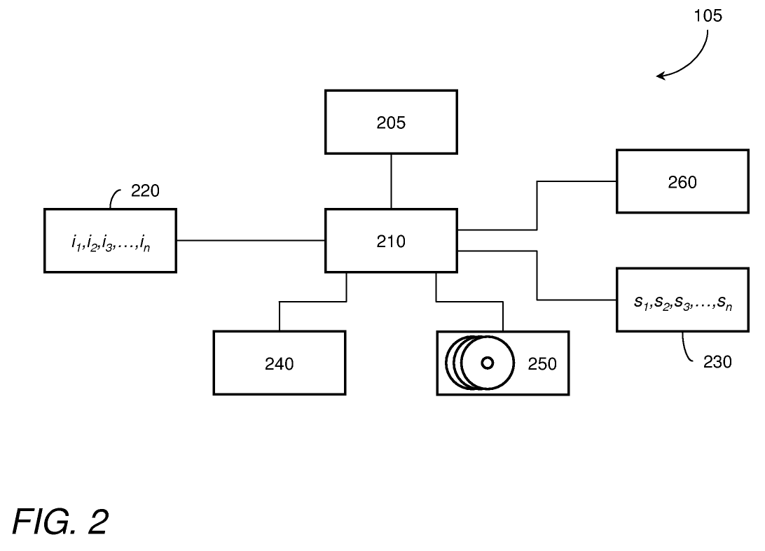

Control system 105 of the invention may be implemented using one or more processors as schematically represented in FIG. 2. Control system 105 may be, for example, a general-purpose computer such as those based on an Intel PENTIUM®-type processor, a Motorola PowerPC® processor, a Sun UltraSPARC® processor, a Hewlett-Packard PA-RISC® processor, or any other type of processor or combinations thereof. Alternatively, the control system may include specially-programmed, special-purpose hardware, for example, an application-specific integrated circuit (ASIC) or controllers intended for analytical systems.

Control system 105 can include one or more processors 205 typically connected to one or more memory devices 250, which can comprise, for example, any one or more of a disk drive memory, a flash memory device, a RAM memory device, or other device for storing data. Memory device 250 is typically used for storing programs and data during operation of the system 100 and/or control system 105. For example, memory device 250 may be used for storing historical data relating to the parameters over a period of time, as well as operating data. Software, including programming code that implements embodiments of the invention, can be stored on a computer readable and/or writeable nonvolatile recording medium, and then typically copied into memory device 250 wherein it can then be executed by processor 205. Such programming code may be written in any of a plurality of programming languages, for example, Java, Visual Basic, C, C#, or C++, Fortran, Pascal, Eiffel, Basic, COBAL, or any of a variety of combinations thereof.

Components of control system 105 may be coupled by an interconnection mechanism 210, which may include one or more busses, e.g., between components that are integrated within a same device, and/or a network, e.g., between components that reside on separate discrete devices. The interconnection mechanism typically enables communications, e.g., data, instructions, to be exchanged between components of the system.

Control system 105 can also include one or more input devices 220 receiving one or more input signals i₁, i₂, i₃, . . . , iₙ, from, for example, a keyboard, mouse, trackball, microphone, touch screen, and one or more output devices 230, generating and transmitting, one or more output, drive or control signals, s₁, s₂, s₃, . . . , sₙ, to for example, a printing device, display screen, or speaker. In addition, control system 105 may contain one or more interfaces 260 that can connect control system 105 to a communication network (not shown) in addition or as an alternative to the network that may be formed by one or more of the components of the system.

According to one or more embodiments of the invention, the one or more input 10 devices 220 may include components, such as but not limited to, valves, pumps, and sensors 106, 107, and 108 that typically provide a measure, indication, or representation of one or more conditions, parameters, or characteristics of one or more components or process streams of system 100. Alternatively, the sensors, the metering valves and/or pumps, or all of these components may be connected to a communication network that is operatively coupled to control system 105. For example, sensors 106, 107, and 108 may be configured as input devices that are directly connected to control system 105, metering valves and/or pumps of subsystems 122 and 124 may be configured as output devices that are connected to control system 200, and any one or more of the above may be coupled to a computer system or an automated system, so as to communicate with control system 200 over a communication network. Such a configuration permits one sensor to be located at a significant distance from another sensor or allow any sensor to be located at a significant distance from any subsystem and/or the controller, while still providing data therebetween.

Control system 105 can comprise one or more storage media such as a computer-readable and/or writeable nonvolatile recording medium in which signals can be stored that define a program or portions thereof to be executed by, for example, one or more processors 205. The one or more storage media may, for example, be or comprise a disk drive or flash memory. In typical operation, processor 205 can cause data, such as code that implements one or more embodiments of the invention, to be read from the one or more storage media into, for example, memory device 240 that allows for faster access to the information by the one or more processors than does the one or more media. Memory device 240 is typically a volatile, random access memory such as a dynamic random access memory (DRAM) or static memory (SRAM) or other suitable devices that facilitates information transfer to and from processor 205.

Although control system 105 is shown by way of example as one type of computer system upon which various aspects of the invention may be practiced, it should be appreciated that the invention is not limited to being implemented in software, or on the computer system as exemplarily shown. Indeed, rather than implemented on, for example, a general purpose computer system, the control system, or components or subsystems thereof, may be implemented as a dedicated system or as a dedicated programmable logic controller (PLC) or in a distributed control system. Further, it should be appreciated that one or more features or aspects of the invention may be implemented in software, hardware or firmware, or any combination thereof. For example, one or more segments of an algorithm executable by processor 205 can be performed in separate computers, each of which can be communication through one or more networks.

System 100 can further comprise a subsystem 176 for sanitizing and/or removing any residue, particulate or other material retained on the surface of the membranes of filtration apparatus 172 and 174. Subsystem 176 can comprise one or more heat exchangers and pumps that allow temperature cycling of the membranes of apparatus 172 and 174. Temperature cycling can be controlled by control system 105 by alternately providing hot and cool water into any of apparatus 172 and 174 to allow expansion and contraction of components thereof which facilitates removal of any retained materials. Although not illustrated, subsystem 176 may also be connected to any unit operation of system 100 to also facilitate cleaning and hot water sanitization of such unit operations.

### EXAMPLE

The function and advantages of these and other embodiments of the invention can be further understood from the example below, which illustrates the benefits and/or advantages of the one or more systems and techniques of the invention but do not exemplify the full scope of the invention.

This example describes a system utilizing the techniques of the invention as substantially represented in the schematic illustration of FIG. 1.

The system 100 is fluidly connectable to a source 110 of inlet water and is designed to provide ultrapure water to a semiconductor fabrication unit having the respective quality and characteristics listed in Table 1.

The source 122 of precursor compound would utilize a pump to provide ammonium persulfate.

The reactor 120 would comprise three serially connected UV lamps (SCD-120) providing UV radiation at about 254 nm.

The chiller 130 would be a plate and frame heat exchanger designed to reduce the water temperature by 3° C.

The lead ion exchange column 140L would include parallel beds of USF™ MEG PPQ ion exchange resin.

The particulate filter 150 would be rated to retain particles greater than 0.05 micron.

The degasifier 160 would include two membrane contactors in parallel connected to a vacuum source 162 at 30 mm Hg.

The pump 166 would utilize a variable speed drive and rated to provide 35 gpm at 100 psig.

The polish ion exchange column 140P would include serially connected beds of USF™ MEG PPQ ion exchange resin.

The ultrafiltration apparatus would utilize OLT-5026G ultrafiltration membranes from Asahi Chemical Company.

The online sensors utilized are listed in Table 2.

TABLE 1

| Property | Inlet Water Quality | Product Water Quality |
|---|---|---|
| TOC as urea, | <1-15 | <1 |
| ppb | | |
| Resistivity, | 18.0 | >18.0 |
| megohm | | |
| Particles @ 0.05 μ, | <1,000 | <100 |
| counts per liter | | |
| Dissolved oxygen, | <100 | <1,000 |
| ppb | | |
| Dissolved nitrogen, | <500 | <1,000 |
| ppb | | |
| Metals | <1 ppb, each | <1 ppt |
| | | Na < 2 ppt |
| Silica, | <3 | <0.75 (total) |
| ppb | | |
| Temperature, | ~24 | 22-23 |
| ° C. | | |

TABLE 2

| Instrument | Manufacturer | Model |
|---|---|---|
| TOC, control | GE Analytical Instruments | SIEVERS 900 turbo |
| TOC, ultrapure | GE Analytical Instruments | SIEVERS 500RL |
| water | | |
| Particulate sensor | Particle Measurement | UDI 50 |
| | Systems | |
| Resistivity | Mettler Toledo | Thornton |
| Dissolved oxygen | Hach Ultra | ORBISPHERE 3621 |
| Dissolved nitrogen | Hach Ultra | ORBISPHERE 3621 |
| Ozone | Hach Ultra | ORBISPHERE MOCA |

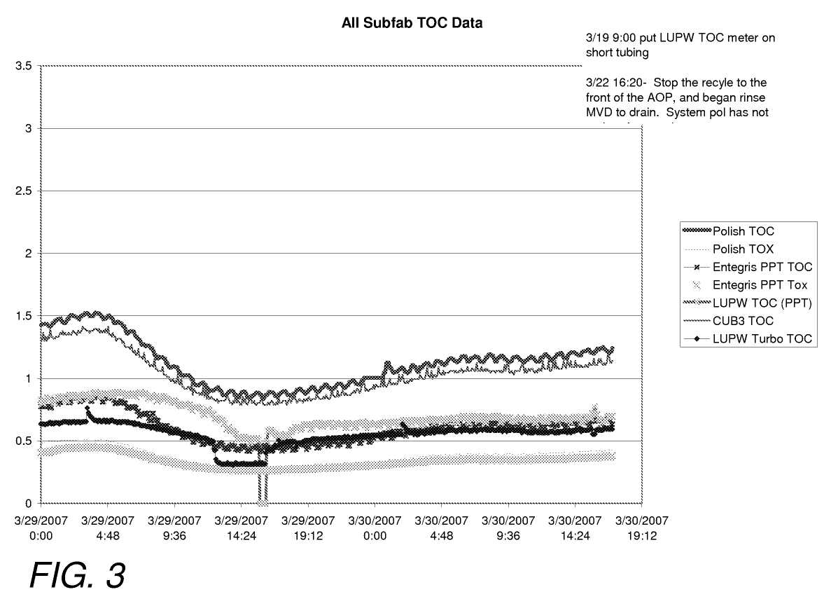

FIG. 3 which presents the quality of the ultrapure water product shows that water having the desired characteristic can be treated by the systems and techniques of the invention (labeled as “LUPW”) and compared to an existing water supply system (labeled as “Polish”) as well as an alternate apparatus (labeled as “Entegris”). As shown in FIG. 3, the systems of the invention can maintain the low TOC levels even during fluctuations in inlet water quality.

Having now described some illustrative embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims. Further, acts, elements, and features discussed only in connection with one embodiment are not intended to be excluded from a similar role in other embodiments.

As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of providing ultrapure water to a semiconductor fabrication unit, comprising acts of:
providing inlet water having a TOC value of less than about 25 ppb;
introducing at least one free radical precursor compound into the water;
converting the at least one free radical precursor compound into at least one free radical scavenging species;
removing at least a portion of any particulates from the water to produce the ultrapure water; and
delivering at least a portion of the ultrapure water to the semiconductor fabrication unit.

2. The method of claim 1, further comprising an act of mixing any unused ultrapure water with the inlet water.

3. The method of claim 1, further comprising an act of mixing at least a portion of any unused ultrapure water with inlet water before performing the act of removing the at least a portion of any particulates from the water.

4. The method of claim 1, further comprising an act of regulating a rate of addition of the at least one precursor compound based at least partially on the TOC value of the inlet water.

5. The method of claim 1, further comprising an act of regulating a rate of addition of the at least one precursor compound based at least partially on a TOC value of the ultrapure water.

6. The method of claim 1, further comprising an act of cooling at least a portion of the ultrapure water to a desired temperature.

7. The method of claim 1, wherein the act of removing the at least a portion of any particulates from the water comprises removing the at least a portion of any particulates in an ultrafiltration apparatus.

8. The method of claim 7, further comprising an act of removing particulates from a retentate stream from the ultrafiltration apparatus.

9. The method of claim 1, further comprising an act of degasifying at least a portion of the ultrapure water before performing the act of delivering the at least a portion of the ultrapure water to the semiconductor fabrication unit.

10. The method of claim 1, further comprising removing at least a portion of any ionized species from the water before performing the act of delivering the at least a portion of the ultrapure water to the semiconductor fabrication unit.

11. A system for providing ultrapure water to a semiconductor fabrication unit, comprising:
a source of water having a TOC value of less than about 25 ppb;
an actinic radiation reactor fluidly connected to the source of water and configured to irradiate water from the source of water;
a source of a precursor compound disposed to introduce a free radical precursor compound to the water; and
a particulate filter fluidly connected downstream of the actinic radiation reactor and upstream of an ultrapure water distribution system fluidly connected to the semiconductor fabrication unit.

12. The system of claim 11, further comprising a recycle line fluidly connecting an outlet port of the ultrapure water distribution system to an inlet port of the actinic radiation reactor.

13. The system of claim 11, further comprising:
a sensor configured to transmit an input signal representative of a property of the water from the source of the water; and
a controller disposed to receive the input signal and to generate a drive signal that regulates a rate of addition of the precursor compound based at least partially on the input signal.

14. The system of claim 13, further comprising a heat exchanger fluidly connected downstream of the actinic radiation reactor and upstream of the ultrapure water distribution system.

15. The system of claim 13, further comprising a first ion exchange bed fluidly connected downstream of the actinic radiation reactor and upstream of the ultrapure water distribution system.

16. The system of claim 15, further comprising a degasifier fluidly connected downstream of the actinic radiation reactor and upstream of the ultrapure water distribution system.

17. The system of claim 16, further comprising an ultrafiltration system fluidly connected downstream of the degasifier and upstream of the ultrapure water distribution system.

18. The system of claim 17, further comprising a particulate filter fluidly connected downstream of a retentate outlet of the ultrafiltration system.

19. The system of claim 17, further comprising a second ion exchange bed fluidly connected downstream of the first ion exchange bed and upstream of the ultrapure water distribution system.

20. A system for treating water, comprising:
a free radical scavenging system fluidly connected to a source of water having a resistivity of at least 15 megohms;
a particulate removal system fluidly connected downstream of the free radical scavenging system;
an ultrapure water delivery system fluidly connected downstream of the particulate removal system, and
a water return system fluidly connecting the ultrapure water delivery system to the free radical scavenging system.

21. The system of claim 20, wherein the free radical scavenging system comprises:
at least one source of a precursor compound, the at least one source disposed to introduce at least one free radical precursor compound into the water; and
at least one source of actinic radiation configured to convert the at least one precursor compound into at least one free radical scavenging species.

22. The system of claim 21, wherein the particulate removal system comprises at least one ultrafiltration apparatus fluidly connected downstream of the at least one source of actinic radiation and upstream of the ultrapure water delivery system.

23. A computer-readable medium having computer-readable signals stored thereon that define instructions that as a result of being executed by at least one processor instruct the at least one processor to perform a method of regulating addition of at least one free radical precursor compound into an inlet water having a TOC value of less than about 25 ppb, comprising acts of:
generating one or more drive signals based at least partially on the TOC value of the inlet water; and
transmitting the one or more drive signals to at least one source of the at least one precursor compound, the at least one source disposed to introduce the at least one precursor compound into the inlet water.

24. The computer-readable medium of claim 23, wherein the method further comprises acts of:
generating one or more control signals based at least partially on the one or more drive signals; and
transmitting the one or more control signals that energizes at least one actinic radiation source disposed to irradiate at least a portion of the inlet water containing the at least one precursor compound.

25. The computer-readable medium of claim 24, wherein the method further comprises acts of:
generating a process signal based at least partially on a temperature of the water downstream of the at least one actinic radiation source; and
transmitting the process signal that actuates a regulator configured to adjust a cooling rate of the water downstream of the at least one actinic radiation source.
